(19) United States
(12) Patent Application Publication
(10) Pub. No.: US 2015/0245981 A1
(43) Pub. Date: Sep. 3, 2015

(54) Teething Bracelet

(71) Applicant: Victoria Barber, Simi Valley, CA (US)

(72) Inventor: Victoria Barber, Simi Valley, CA (US)

(21) Appl. No.: 14/194,715

(22) Filed: Mar. 1, 2014

(51) Int. Cl. A61J 17/02

(52) U.S. Cl. CPC A61J 17/02

(57) ABSTRACT

A bracelet to be worn by an adult caretaker of an infant or baby is disclosed. A washable terry cloth bracelet fastens around the wearer's wrist with hook and loop fabric or other suitable fastener. A plurality of loops is sewn to the bracelet around its lower circumference and retains a set of teething rings. The rings may be removable or non-removable. In addition, a plurality of smaller loops is also sewn to the lower circumference of the bracelet. These loops may be used to attach additional toys, charms and other articles that wearer may like to provide for the baby or display. The bracelet, large and small loops, and teething rings may be provided in a wide variety of colors, shapes, patterns, styles, and designs.

### CROSS-REFERENCE TO RELATED APPLICATIONS

Not Applicable

### STATEMENT REGARDING FEDERALLY SPONSORED RESEARCH OR DEVELOPMENT

Not Applicable

### PARTIES TO A JOINT RESEARCH AGREEMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The invention relates generally to the field of teething toys, and in particular to the field of teething toys that are worn by a parent or caretaker. Teething toys for babies are well-known; chewable, bendable, and deformable plastic objects are generally provided, often with textured surfaces, which are understood to be tactilely interesting to babies and soothing to teething gums when chewed upon. Universally, such toys are frequently soiled by dropping as baby users lose their grips or spit the toys out. To address this, the instant invention is directed toward attaching the teething toy to the wrist of a parent or caretaker.

### SUMMARY OF THE INVENTION

Accordingly, the invention is directed to a bracelet to be worn by an adult caretaker of an infant or baby. A washable terry cloth bracelet fastens around the wearer's wrist with hook and loop fabric or other suitable fastener. A plurality of loops is sewn to the bracelet around its lower circumference and retains a set of teething rings. The rings may be removable or non-removable. In addition, a plurality of smaller loops is also sewn to the lower circumference of the bracelet. These loops may be used to attach additional toys, charms and other articles that wearer may like to provide for the baby or display. The bracelet, large and small loops, and teething rings may be provided in a wide variety of colors, shapes, patterns, styles, and designs.

Additional features and advantages of the invention will be set forth in the description which follows, and will be apparent from the description, or may be learned by practice of the invention. The foregoing general description and the following detailed description are exemplary and explanatory and are intended to provide further explanation of the invention.

### BRIEF DESCRIPTION OF THE DRAWINGS

The accompanying drawings are included to provide a further understanding of the invention and are incorporated into and constitute a part of the specification. They illustrate one embodiment of the invention and, together with the description, serve to explain the principles of the invention.

FIG. 1 shows a front view of the first exemplary embodiment, displaying the bracelet 100, large loops 101, small loops 102, and toys 103.

FIG. 2 shows a rear view of the first exemplary embodiment, displaying the bracelet 100, large loops 101, small loops 102, toys 103, and fastener 200.

FIG. 3 shows a scene of the first exemplary embodiment in use, displaying the bracelet 100, large loops 101, small loops 102, toys 103, caretaker 300, and baby 301.

### DETAILED DESCRIPTION OF THE INVENTION

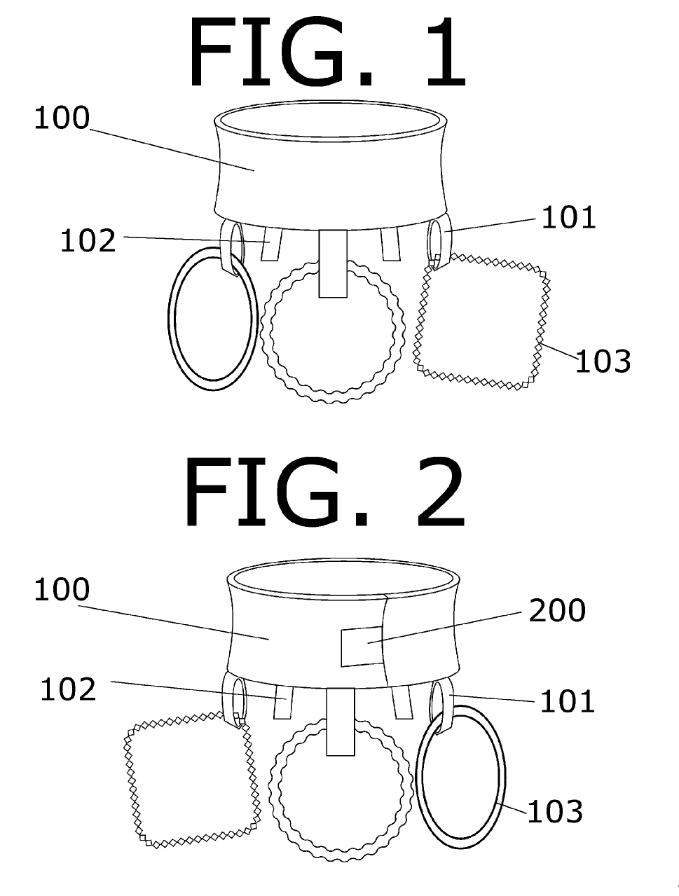

Referring now to the invention in more detail, the invention is directed to a bracelet to be worn by an adult caretaker of an infant or baby. FIG. 1 shows a front view of the first exemplary embodiment. In the first exemplary embodiment, a bracelet 100 is provided. The bracelet 100 is sized to fit around the wrist of an adult user. The bracelet 100 is preferably made of a soft fabric material, for example knit terry cloth. FIG. 2 shows the first exemplary embodiment viewed from the back. Visible in FIG. 2 is a seam and fastener 200. The fastener 200 is preferably a hook and loop fastener, although other fasteners such as buttons, snaps, hooks, and the like may also be used. The material of the bracelet 100 may be provided in any color, pattern, or print, and may bear any indicia (e.g. popular sports team logos).

Sewn or otherwise attached to the lower circumference of the bracelet 100 is a plurality of large loops 101 and small loops 102. The loops 101 and 102 may be made of fabric, ribbon, yarn, or similar material and are preferably attached with reinforced stitching or other fastener of high tensile strength as the loops 101 and 102 may experience substantial pulling forces during use. The loops 101 and 102 are fastened on both sides as opposed to being openable or removable. The linked objects are limited to permanently attached objects placed at the time of manufacture or removable objects which themselves may link around a fixed loop. As with the bracelet 100, the loops 101 and 102 may be provided in any color, pattern, or print or bear any indicia.

Linked to the large loops 101 is a plurality of toys or teething objects 103, for example the rings of various shapes and sizes shown. The teething toys 103 are preferably made of durable and flexible non-toxic plastic materials (i.e. “teething-safe”), and suitable for mechanized cleaning in a washing machine or dishwasher (i.e. “dishwasher-safe”). The teething toys 103 are preferably provided in a variety of colors, patterns, designs, and surface textures. Any of the teething toys 103 may contain a freezable liquid within a hollow cavity to allow the toy to provide a soothing cold sensation to the baby user. The teething toys 103 may be permanently linked to the large loops 101 at the time of manufacture, or may be made removable through a gap or fastening mechanism in their own structure. The small loops 102 are preferably left unfilled at the time of manufacture for the user to attach his or her own toys or objects of interest.

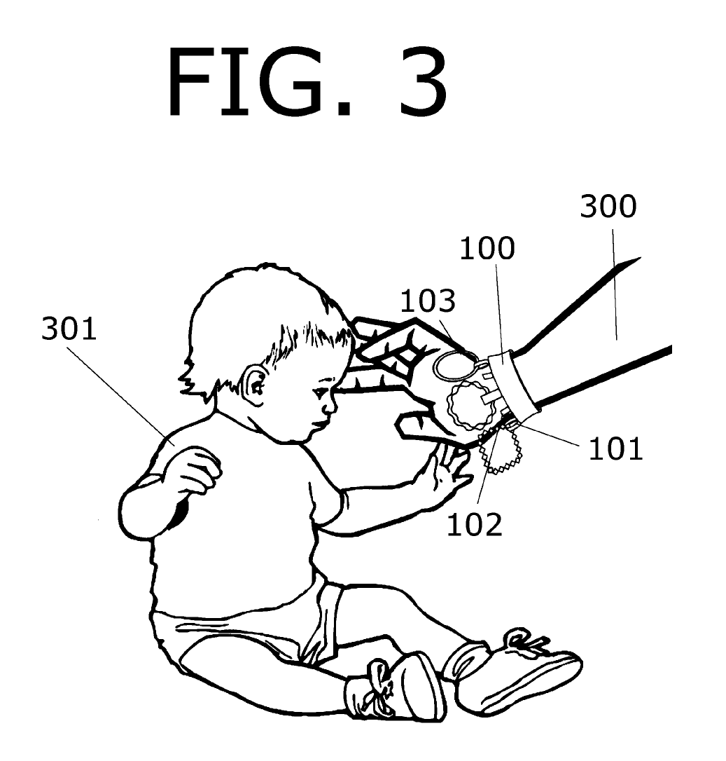

FIG. 3 shows the invention in use. In the scene of FIG. 3, a caretaker 300 wears the bracelet 100 on her wrist. The wearer presents the toys 103 to a baby 301 to play with and/or chew. The baby 301 as shown is older and capable of sitting up, however the invention is appropriate for children from birth, through the onset of teething (as early as 3 months), and up through the end of teething and interest in textured chew toys (as late as 18 months).

Components, component sizes, and materials listed above are preferable, but artisans will recognize that alternate components and materials could be selected without altering the scope of the invention.

While the foregoing written description of the invention enables one of ordinary skill to make and use what is presently considered to be the best mode thereof, those of ordinary skill in the art will understand and appreciate the existence of variations, combinations, and equivalents of the specific embodiment, method, and examples herein. The invention should, therefore, not be limited by the above described embodiment, method, and examples, but by all embodiments and methods within the scope and spirit of the invention.

I claim:

1. A bracelet for use by the adult caregiver of a baby comprising a bracelet, at least one loop, said at least one loop being non-releasably attached to said bracelet, at least one toy, said at least one toy being shaped so as to be releasably or non-releasably interlinked with said at least one loop.

2. The bracelet of claim 1 wherein said bracelet further comprises a releasable fastening means for fastening said bracelet to the wrist of said adult caregiver.

3. The bracelet of claim 1 wherein said at least one loop comprises a plurality of large loops and a plurality of small loops, said large loops being relatively larger in diameter than said small loops, and said at least one toy being shaped so as to be releasably or non-releasably interlinked with said plurality of large loops.

4. The bracelet of claim 3 wherein said plurality of small loops is suitable for attachment of any of the group of toys, teething items, and small objects of interest by said adult caregiver.

5. The bracelet of claim 1 wherein said at least one toy is non-releasably interlinked with said at least one loop at the time of manufacture.

6. The bracelet of claim 2 wherein said at least one toy is non-releasably interlinked with said at least one loop at the time of manufacture.

7. The bracelet of claim 3 wherein said at least one toy is non-releasably interlinked with said at least one loop at the time of manufacture.

8. The bracelet of claim 4 wherein said at least one toy is non-releasably interlinked with said at least one loop at the time of manufacture.

9. The bracelet of claim 5 wherein said at least one toy is non-releasably interlinked with said at least one loop at the time of manufacture.

10. The bracelet of claim 1 wherein said at least one toy is teething-safe and dishwasher-safe.

11. The bracelet of claim 2 wherein said at least one toy is teething-safe and dishwasher-safe.

12. The bracelet of claim 3 wherein said at least one toy is teething-safe and dishwasher-safe.

13. The bracelet of claim 4 wherein said at least one toy is teething-safe and dishwasher-safe.

14. The bracelet of claim 5 wherein said at least one toy is teething-safe and dishwasher-safe.

15. The bracelet of claim 6 wherein said at least one toy is teething-safe and dishwasher-safe.

16. The bracelet of claim 7 wherein said at least one toy is teething-safe and dishwasher-safe.

17. The bracelet of claim 8 wherein said at least one toy is teething-safe and dishwasher-safe.

18. The bracelet of claim 9 wherein said at least one toy is teething-safe and dishwasher-safe.
